(19) United States
(12) Patent Application Publication
(10) Pub. No.: US 2025/0278310 A1
(43) Pub. Date: Sep. 4, 2025

(54) LIVE METRIC AUTO-SCALING LEVERAGING TELEMETRY SERVICES

(71) Applicant: Snowflake Inc., Bozeman, MT (US)

(72) Inventors: Kuan-Yu Li, Sunnyvale, CA (US); Rares Radut, San Mateo, CA (US); Yuanfeng Wen, Sunnyvale, CA (US)

(21) Appl. No.: 18/591,972

(22) Filed: Feb. 29, 2024

Related U.S. Application Data
(63) Continuation of application No. 18/591,462, filed on Feb. 29, 2024.

(51) Int. Cl. G06F 9/50

(52) U.S. Cl. CPC G06F 9/5083

(57) ABSTRACT

Autoscaling techniques can optimize usage of computing resources in a data system while also quickly reacting to change in workloads. The computing resources are arranged in different clusters. Autoscaling can be partitioned into two separate, independent autoscaling phases: a slow autoscaler and a fast autoscaler.

### PRIORITY CLAIM

This application is a Continuation of U.S. patent application Ser. No. 18/591,462, filed Feb. 29, 2024, the contents of which are hereby incorporated by reference in their entirety.

### TECHNICAL FIELD

The present disclosure generally relates to flexible computing, in particular autoscaling clusters in a data system reactively with low latency.

### BACKGROUND

As the world becomes more data driven, database systems and other data systems are storing more and more data. For a business to use this data, different operations or queries are typically run on this large amount of data. Some operations, for example those including large table scans or executing multiple queries, can take a substantial amount of time to execute on a large amount of data. The time to execute such operations can be proportional to the number of computing resources used for execution, so time can be shortened using more computing resources.

Some data systems can provide a pool of computing resources, and those resources can be assigned to execute different operations. However, in such systems, the assigned computing resources typically work in conjunction, for example in a cluster group. Their assignments can be fixed and static. A computing resource can remain assigned to an operation, which no longer needs that computing resource. The assignments of those computing resources cannot be easily modified in response to demand changes. Hence, the computing resources are not utilized to their full capacity.

### BRIEF DESCRIPTION OF THE DRAWINGS

Various ones of the appended drawings merely illustrate example embodiments of the present disclosure and should not be considered as limiting its scope.

FIG. 1 is a block diagram illustrating an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a block diagram illustrating example portions of a data system configured for autoscaling, according to some example embodiments.

FIG. 5 is a block diagram illustrating an autoscaling system, according to some example embodiments.

FIG. 6 shows a flow diagram of a method for slow autoscaling, according to some example embodiments.

FIG. 7 shows a flow diagram a method for fast autoscaling, according to some example embodiments.

FIG. 8 is a flow diagram for a method for conflict resolution of autoscaling decisions, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Autoscaling techniques described herein can optimize usage of computing resources in a data system while also quickly reacting to change in workloads. The computing resources are arranged in different clusters. Autoscaling can be partitioned into two separate, independent autoscaling phases: a slow autoscaler and a fast autoscaler. The slow autoscaler may operate on a slower periodic manner (e.g., every minute) and may utilize a large dataset relating to current, historical, and predicted workload conditions at the different computing resources. The large dataset may be stored in a metadata database and retrieved by the slow autoscaler to perform autoscaling. The slow autoscaler can change cluster configurations in different manners, such as scaling in or scaling out the size of the cluster and scaling up or scaling down the type of computing resources in the cluster.

The fast autoscaler, on the other hand, may be dedicated to performing only a subsection of auto-scaling actions (e.g., only scaling out) that are reactive to change in workloads, such as a sharp increase in workload. The autoscaling action of the fast autoscaler may be based on a subset of workload information most pertinent to the dedicated autoscaling action (e.g., scaling out). The subset of workload information may be collected using a real-time telemetry service and the real-time telemetry data may be stored in memory, allowing for faster retrieval. Thus, the subsection of autoscaling actions can be performed more frequently (e.g., every few seconds) and more accurately. The slow autoscaler and fast autoscaler operate independently and can have conflict resolution functionalities.

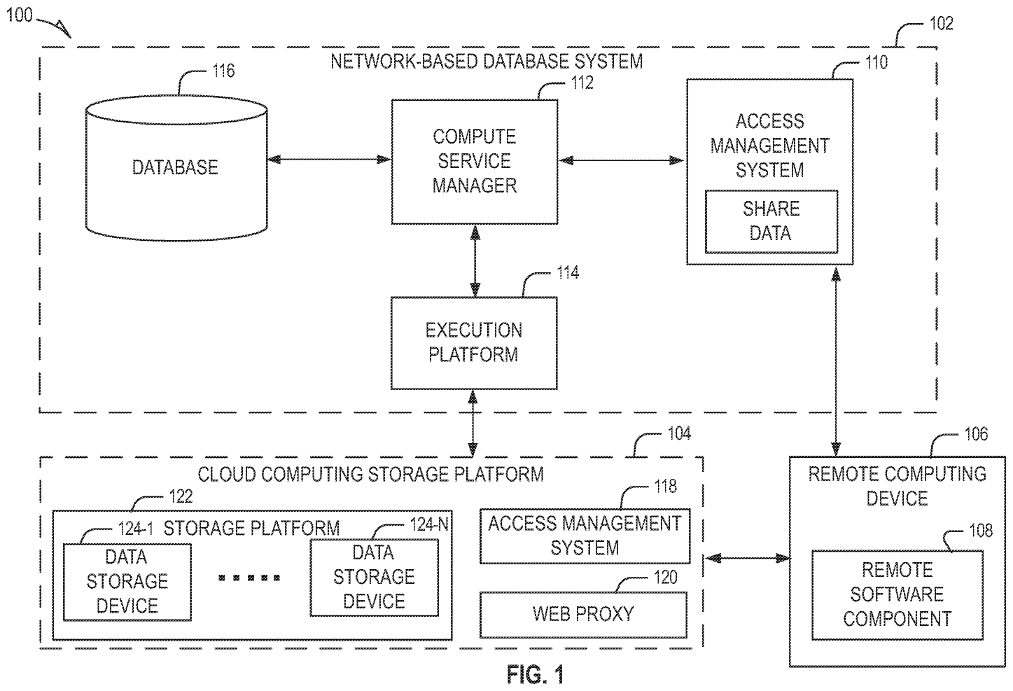

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

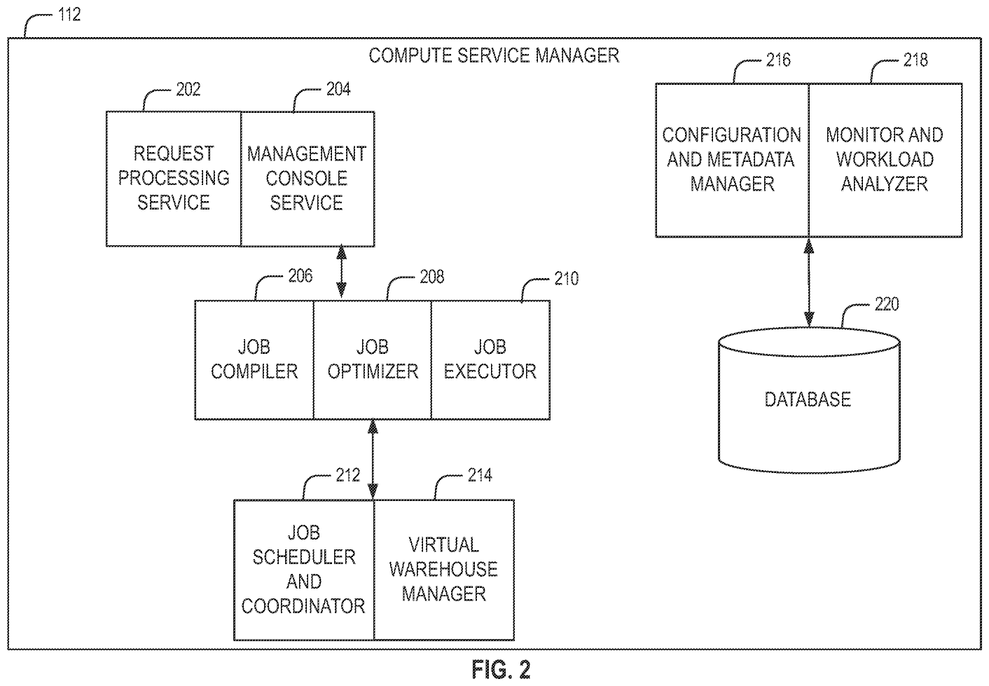

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

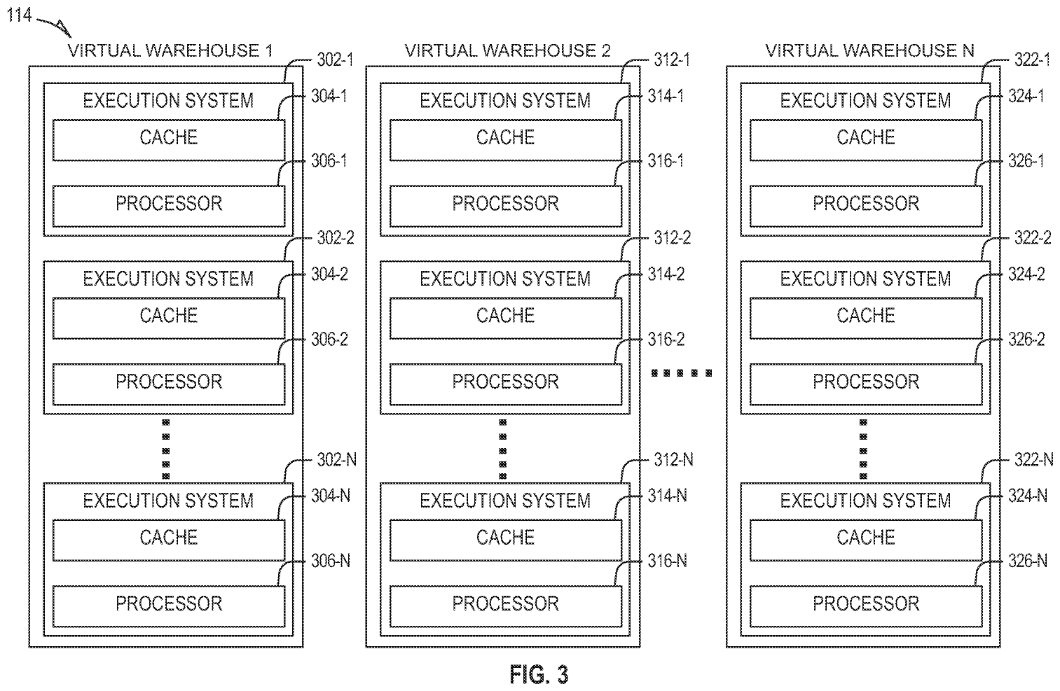

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Computing resources described above may be arranged in clusters. For example, one or more compute service managers 112 may be arranged in a cluster with the data system including a plurality of clusters of one or more compute service managers 112. The cluster configurations can be dynamically adjusted.

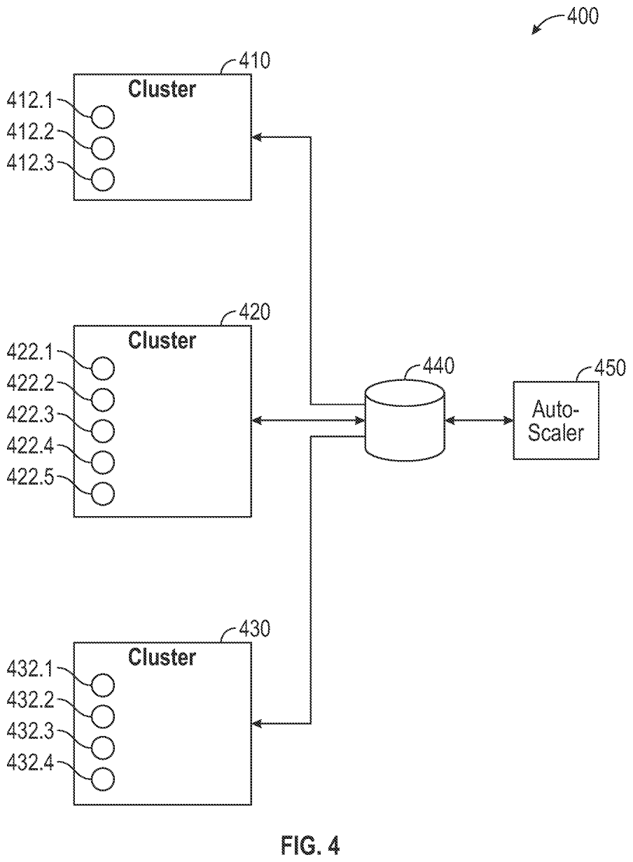

Next, autoscaling techniques to dynamically change cluster configurations will be described. FIG. 4 is a block diagram illustrating example portions of a data system 400 configured for autoscaling, according to some example embodiments. The data system 400 includes a plurality of foreground clusters 410, 420, 430. Each foreground cluster includes a plurality of computing resources (also referred to as nodes, instances, servers). The computing resources may be provided as compute service managers described above (e.g., compute service manager 112).

In this example, foreground cluster 410 includes computing resources 412.1-412.3; foreground cluster 420 includes computing resources 422.1-422.5; and foreground cluster 430 includes computing resources 432.1-432.4. The foreground clusters may have different number of computing resources, and the number of computing resources assigned to each cluster may change based on the autoscaling techniques, described in further detail below.

A foreground cluster may be assigned to a group of accounts in a multi-tenancy embodiment. A foreground cluster may be assigned to a single account in a dedicated-cluster embodiment. The foreground clusters may receive requests or queries and develop query plans to execute the queries. The foreground clusters may broker requests to execution platforms that execute the query plans. The foreground clusters may receive query requests from different sources, which may have different account IDs. For certain operations, such as those involving multiple computing resources working together to execute different portions of an operation (e.g., large table scans), the source may be defined at a data warehouse level granularity.

The computing resources may be computing nodes allocated to the data system 400 from a pool of computing resources. In some embodiments, the computing resources may be machines, servers, CPUs, and/or processors.

The clusters 410, 420, 430 communicate with a centralized autoscaler 450 over a network. In some embodiments, communications between the clusters 410, 420, 430 and autoscaler 450 may be performed via a metadata database 440. That is, the components in the clusters 410, 420, 430 may transmit messages, for example relating to their current workloads, to the metadata database 440, where the information from those messages may be stored. A reverse proxy server can route requests across the components in the clusters 410, 420, 430 and the autoscaler 450 may read the information sent by the clusters 410, 420, 430 from the metadata database 440.

In some embodiments, communications between the clusters 410, 420, 430 and the autoscaler 450 is also performed directly via, for example, remote procedure calls such as gRPCs, as described in further detail below.

The autoscaler 450 may be coupled to a cloud resource provider (not shown). The cloud resource provider may maintain a pool of computing resources. The computing resources may be of different types and have different specifications, as described in further detail below. In some embodiments, the autoscaler 450 may communicate with a communication layer over the cloud resource provider.

Some conventional autoscaling techniques can be slow to changes in workload conditions in clusters. As described below, autoscaling functionality of autoscaler 450 can be partitioned to be more reactive to change in workloads.

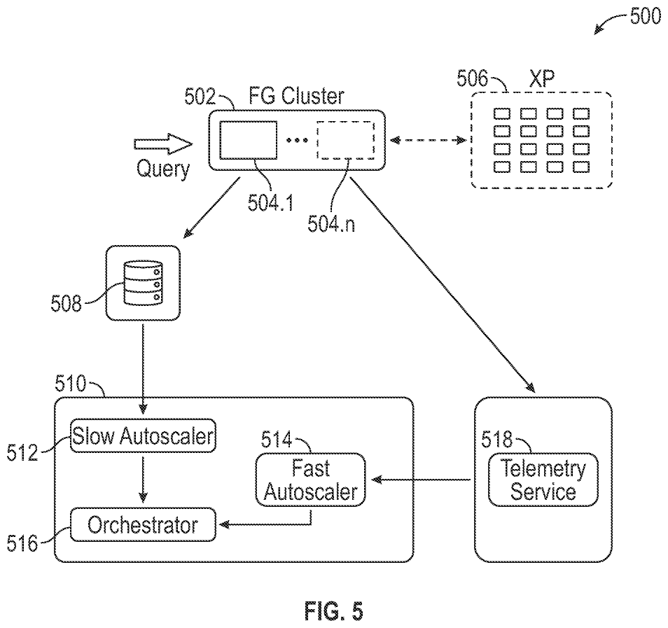

FIG. 5 is a block diagram illustrating an autoscaling system 500, according to some example embodiments. The autoscaling system includes a foreground cluster 502 including one or more computing resources 504.1-504.n. As described above, the computing resources may include compute service managers (e.g., compute service manager 112). The computing resources may coordinate with one or more execution platforms 506 (e.g., execution platform 114) comprising a plurality of computing nodes (e.g., virtual warehouses as described above).

In operation, queries are received by the foreground cluster 502. For example, the queries are received from clients (e.g., via remote computing devices 106. The computing resources 504.1-504.n (e.g., compute service managers 112) can generate query plans and assign one or more execution platforms 506 to execute the query plans to generate results. The number and type of computing resources 504.1-504.n may be dynamically changed. One foreground cluster 502 is shown here for simplicity; however, it should be understood that the system can include a plurality of foreground clusters as described above, for example, with reference to FIG. 4.

The foreground cluster 502 is coupled to a metadata database 508. The computing resources 504.1-504.n may transmit messages about their workload to the metadata database 508. The metadata database 508, in turn, stores workload conditions of the computing resources 504.1-504.n. The metadata database 508 can also store historical workload information relating to historical trends as well as future scheduled workload information.

The metadata database 508 is coupled to an autoscaler cluster 510. The autoscaler cluster 510 may be provided as a background service to the data system. The autoscaler cluster 510 may include a slow autoscaler 512, a fast autoscaler 514, and an orchestrator 516.

The slow autoscaler 512 may obtain information about the workload conditions of the computing resources 504.1-504.n in foreground cluster 502 and other computing resources in other clusters (not shown) from the metadata database 508. For example, the slow autoscaler 512 can read data persistent objects (DPOs) relating to workload conditions of the different clusters stored in the metadata database 508. The slow autoscaler 512 can retrieve also historical workload information relating to historical trends as well as future scheduled workload information from the metadata database 508.

The slow autoscaler 512 may then determine cluster adjustments based on the information obtained from the metadata database 508. The slow autoscaler 512 may determine the adjustments on a periodic manner, say every 1 minute. The slow autoscaler 512 may transmit the adjustments to the orchestrator 516, which makes the adjustments to the cluster configurations. For example, the orchestrator 516 may communicate with a cloud resource provider to add and remove computing resources from different clusters. The orchestrator 516 may be provided as a compute service manager as described herein (compute service manager 112).

The adjustments may include instructions for scaling in or out a cluster. Scaling out refers to adding one or more computing resources to a cluster. Scaling in refers to removing one or more computing resources from a cluster. Scaling in or out may be done incrementally. For example, the slow autoscaler 512 may scale out by a maximum of two computing resources in a given iteration. The slow autoscaler 512 may scale in by a maximum of one computing resource in a given iteration. These limits may help avoid oscillation.

The slow autoscaler 512 may also adjust the type of computing resources assigned to each cluster. One resource type may be assigned per cluster. That is, all computing resources of a cluster may be the same type. The slow autoscaler 512 may scale up or down (or keep the same) the type of computing resources for the cluster. Scaling up refers to changing the computing resources of a cluster with computing resources with a higher level. Scaling down refers to changing the computing resources of a cluster with computing resources with a lower level. These higher or lower levels may refer to specification aspects of the computing resources, such as CPU speed and memory capacity.

Scaling up or down may address situations not adequately addressed by adding or removing computing resources. These situations may include memory issues. Simply adding or removing computing resources may not adequately address memory issues facing those computing resources. For example, if a computing resource is determined to have not enough memory to perform certain tasks, the slow autoscaler 512 may scale up the computing resources for that cluster to computing resources with larger memories. In another example, the slow autoscaler 512 may scale down the computing resources of a cluster if it is determined that the tasks assigned to that cluster can be performed with computing resources with smaller memories or other specification aspects. Scaling down may reduce costs.

High and low thresholds may be set to determine the best suited type and number of computing resources for each cluster. This may be done predictively based on the high and low thresholds so a critical failure is not reached. Moreover, historical trends, such as recent history, may be taken into consideration in the selection.

As described above, the slow autoscaler 512 can make different types of cluster configuration adjustments (scale in, out, up, down) because the slow autoscaler 512 bases the adjustments on detailed information regarding current, historical, projected workload conditions of the computing resources. However, the slow autoscaler 512 may not operate at a fast enough frequency to handle quick bursts of computing demands, causing possible latency issues.

The fast autoscaler 514, on the other hand, can be configured to handle quick bursts of computing demands. The fast autoscaler 514 is configured to make limited (or dedicated) cluster configuration adjustments based on a subset of workload information in a faster manner than the slow autoscaler 512. For example, the fast autoscaler 514 can be configured to making only scaling out (i.e., adding more computing resources) determinations. Also, the fast autoscaler 514 may obtain the subset of workload information about the computing resources from a telemetry service 518. The subset of information may include current CPU load and rejection rate information. The computing resources 504.1-504.n may transmit the subset of workload information to the telemetry service 518 using gRPC calls more frequently as compared to sending workload information to the metadata database 508. Also, the telemetry service 518 may store the subset of workload information in memory, which makes retrieval of the subset of workload information by the fast autoscaler 514 faster as compared to obtaining the workload information from persistent storage in the metadata database 508.

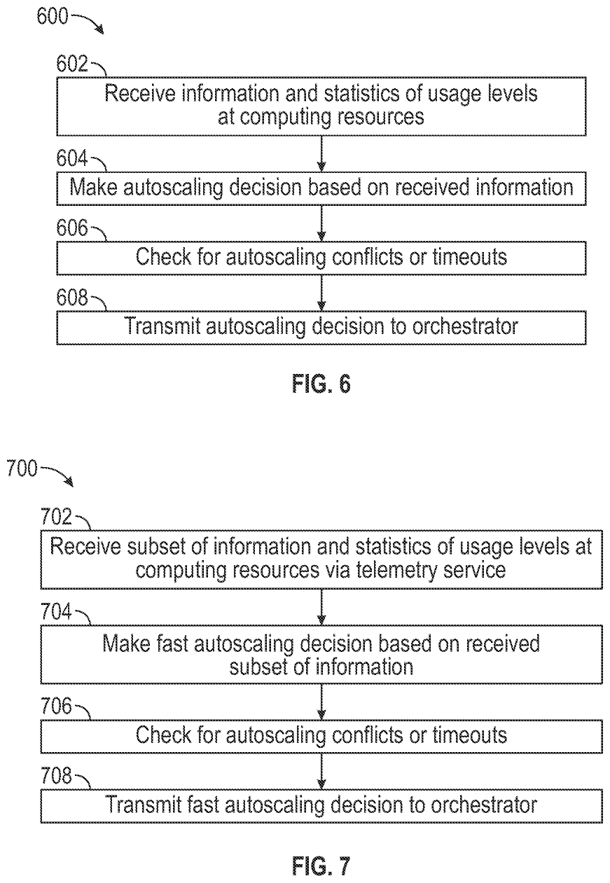

FIG. 6 shows a flow diagram of a method 600 for slow autoscaling, according to some example embodiments. For example, method 600 may be executed by slow autoscaler 512 in an iterative manner as described above.

At operation 602, information and statistics related to usage levels at different computing resources arranged in one or more clusters are received. For example, the slow autoscaler may read the information and statistics from the metadata database on a periodic basis (e.g., every minute). This information may include usage level on a per-node basis. This information received may include load average, rate of rejections (e.g., total number of rejections/number of requests), etc.

This information may also include notification of garbage collection (GC) moments, such as a full GC moment, and out-of-memory errors. The information may also include an indication of any requests that may have been terminated. For example, if a query is received and the parse tree for that query is relatively large and is memory intensive, that query may be terminated before execution to prevent other errors such as an out-of-memory error.

In some embodiments, the information and statistics are stored in different data persistent objects (DPOs) in the metadata database. A service mapping DPO can include information about which service types are being performed by the computing resources in a respective cluster. A cluster resource usage DPO can include historical data for a cluster. An instance DPO can include resource usage information of a respective computing resource. For example, the instance DPO can include current state information of the node, such as CPU load average and rejection rate. A cluster DPO can include information about the current instance count in a respective cluster. A scaling decision DPO can include information about recent scaling decisions made to a respective cluster. The information in the scaling decision DPO can be used to determine timeouts for consecutive scaling decisions.

At operation 604, an autoscaling decision is made based on the received information and statistics. For example, the slow autoscaler may determine to scale in/out/up/down one or more clusters based on the received information and statistics.

At operation 606, the autoscaling decision is checked for conflicts or timeouts. A conflict refers to a substantially simultaneous autoscaling decision by another autoscaler, such as a fast autoscaler. In the event of a conflict, a conflict resolution procedure is invoked as described in further detail below. Timeout refers a buffer period after a specified autoscaling decision is executed where a subsequent autoscaling decision is prevented from being executed. For example, after a scale-out decision a three-minute timeout period can be used to prevent overscaling. In some embodiments, the slow autoscaler can read information from the cluster DPO and scaling decision DPO in the metadata database for conflict and timeout checks.

At operation 608, the autoscaling decision is transmitted to the orchestrator. The orchestrator may then make the cluster configuration adjustments based on the autoscaling decision. For example, the orchestrator may transmit instructions for a computing resource to drop from a first cluster and join a second cluster. As mentioned above, the autoscaling decision here can be for different autoscaling actions, such as scaling in, scaling out, scaling up, scaling down, etc. However, the slow autoscaling decision may not be able to account for quick bursts of resource demands.

FIG. 7 shows a flow diagram a method 700 for fast autoscaling, according to some example embodiments. For example, method 700 may be executed by fast autoscaler 514 in an iterative manner as described above.

At operation 702, a subset of information and statistics about related to usage levels at different computing resources arranged in one or more clusters is received using a telemetry service. For example, each computing resource may transmit the subset of information and statistics related to its usage level to the telemetry service using gRPC calls on a more frequent basis (e.g., every few seconds). The subset of information and statistics may include CPU load and rejection rate information. This subset of information and statistics may be most relevant for scaling out decisions.

The telemetry service can store this subset information and statistics in memory. For example, the telemetry service can store subset of information and statistics in an in-memory cache. The fast autoscaler can read the subset of information and statistics from the in memory of telemetry service on faster periodic basis (e.g., every few seconds) as compared to the slow autoscaler reading the large dataset of information statistics from the metadata database (e.g., every minute). Reading from an in memory is also faster as compared to reading DPOs from the meta database as used by the slow autoscaler, leading to further reductions in latency.

At operation 704, a fast-autoscaling decision is made based on the received subset of information and statistics. For example, the fast autoscaler may determine to scale out one or more clusters based on the received information and statistics. The fast autoscaler may be limited to only scaling out operations. In these embodiments, the fast autoscaler cannot scale in, scale up, or scale down clusters because more detailed information is typically needed to make those scaling decisions.

At operation 706, the fast-autoscaling decision is checked for conflicts or timeouts. A conflict refers to a simultaneous autoscaling decision by another autoscaler, such as a slow autoscaler. In the event of a conflict, a conflict resolution procedure is invoked as described in further detail below. In some embodiments, the fast autoscaler can read information from the cluster DPO and scaling decision DPO in the metadata database for conflict and timeout checks.

At operation 708, the fast-autoscaling decision is transmitted to the orchestrator. The orchestrator may then make the cluster configuration adjustments based on the fast-autoscaling decision. For example, the orchestrator may transmit instructions for a computing resource to join a specified cluster to scale out that cluster. Therefore, clusters can be scaled out in a rapid manner using the fast-autoscaling techniques to handle demand bursts and maintain performance efficiency that cannot be handled by the slow autoscaler alone.

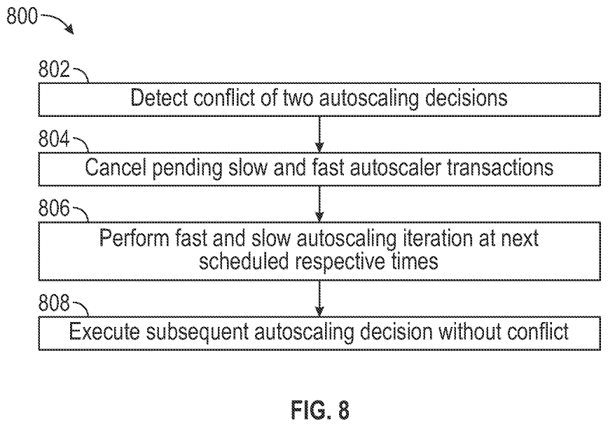

As mentioned above, there may be a conflict between autoscaling decisions made by the slow autoscaler and fast autoscaler. FIG. 8 is a flow diagram for a method 800 for conflict resolution of autoscaling decisions, according to some example embodiments.

At operation 802, two autoscaling decisions are detected at substantially a first time (t1) for a potential conflict. For example, the slow autoscaler can detect a pending fast autoscaling decision made but not yet executed. Likewise, the fast autoscaler can detect a pending slow autoscaling decision made but not yet executed. The conflict may be detected by reading the cluster DPO and scaling decision DPO in the metadata database.

At operation 804, both the fast autoscaler and slow autoscaler cancel their respective autoscaling pending transactions based on the detected conflict.

At operation 806, the fast autoscaler and the slow autoscaler each perform their next autoscaling iteration at the specified time. For the fast autoscaler, the next iteration is performed a few seconds later (time t2) because it runs every few seconds. For the slow autoscaler, the next iteration is performed later than the fast-autoscaling iteration (time t3) because the slow autoscaling is performed on a less frequent basis, such as every minute compared to every few seconds.

At operation 808, the fast-autoscaling decision is the subsequent iteration is executed by the orchestrator. Because the fast autoscaler runs at a more frequent speed, the fast autoscaler will retry its autoscaling decision (at time t2) and will not be then interrupted by the slow autoscaler and hence there will no conflict at the subsequent iteration of the fast autoscaling.

In some cases, a first autoscaler (say, fast autoscaler) can detect that a second autoscaler (say, slow autoscaler) has changed the cluster information dataset (i.e., completed its transaction) before the first autoscaler generates its autoscaling decision. In this scenario, the first autoscaler may cancel its transaction and wait until its next iteration to perform autoscaling based on the current cluster information dataset, which will include the changes based on the completed transaction of the second autoscaler.

In some examples, timeout parameters can be pre-configured. The timeout logic can be specific for the direction of the autoscaling decisions. For example, the timeout period between two consecutive scaling-out decisions can be one minute. For example, the timeout period between scaling out and then scaling can be set for a longer time, such as fifteen minutes. Scaling down may have the largest timeout period because scaling down decisions may have the most impact on cluster performance.

To further increase the speed at which the data system can match computing resources for quick bursting workloads, the data system can track the time at which new nodes (computing resources) finish cache warming and are able to take new traffic. Thus, the data system can perform consecutive scale-out actions based on the time of cache warming of instances actively added to a respective cluster rather than a fixed timeout so the time between increasing cluster size is dynamic.

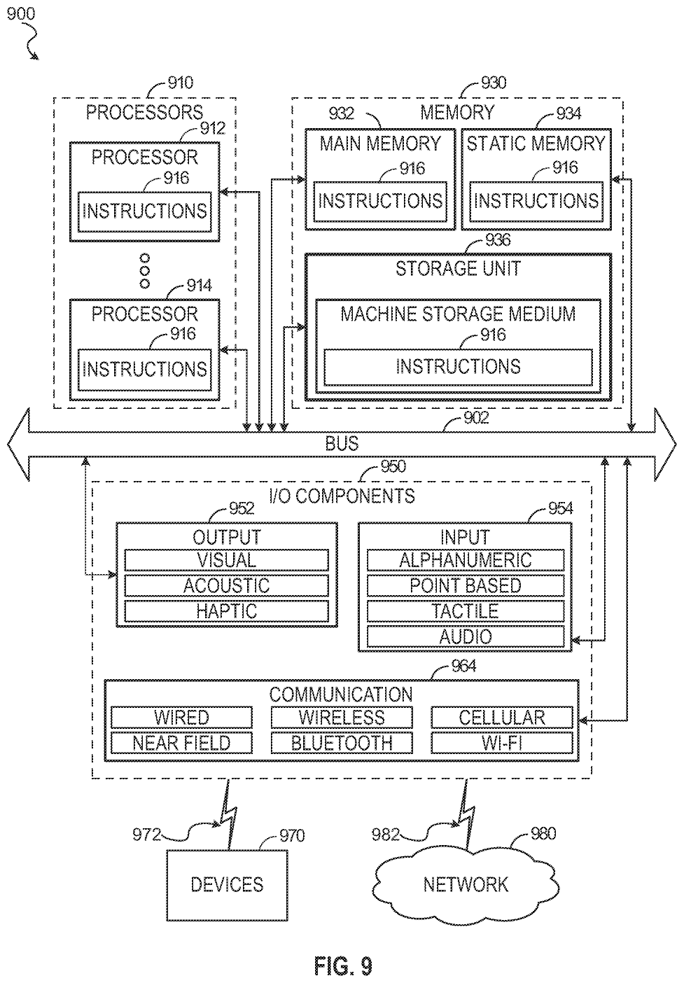

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute any one or more operations of any one or more of the methods described herein. As another example, the instructions 916 may cause the machine 900 to implement portions of the data flows described herein. In this way, the instructions 916 transform a general, non-programmed machine into a particular machine 900 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and input/output (I/O) components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the remote computing device 106, the access management system 118, the compute service manager 112, the execution platform 114, the access management system 110, the Web proxy 120, and the devices 970 may include any other of these systems and devices.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, by a telemetry service, real-time workload information from a plurality of computing resources arranged in one or more clusters in a network-based data system; storing the real-time workload information in an in-memory storage location; retrieving, by at least one hardware processor of a dedicated autoscaler, the real-time workload information; generating a dedicated autoscaling action based on the real-time workload information; and executing the dedicated autoscaling action to change a configuration of at least one cluster of the one or more clusters.

Example 2. The method of example 1, wherein the dedicated autoscaling action is a scaling out to add one or more computing resources to the at least one cluster.

Example 3. The method of any of examples 1-2, wherein the dedicated autoscaler is limited to performing only scaling out autoscaling actions.

Example 4. The method of any of examples 1-3, wherein the telemetry service receives remote procedure calls from each of the plurality of computing resources with the real-time workload information.

Example 5. The method of any of examples 1-4, wherein the real-time workload information includes CPU usage and rejection rate.

Example 6. The method of any of examples 1-5, wherein the real-time workload information is a subset of dataset of workload information, wherein the dataset of workload information is received by a non-dedicated autoscaler, wherein the non-dedicated autoscaler is configured to perform a plurality of different autoscaling functions.

Example 7. The method of any of examples 1-6, wherein the dedicated autoscaler and the non-dedicated autoscaler perform autoscaling actions independently.

Example 8. A system comprising: one or more processors of a machine; and a memory storing instructions that, when executed by the one or more processors, cause the machine to perform operations implementing any one of example methods 1 to 9.

Example 9. A machine-readable storage device embodying instructions that, when executed by a machine, cause the machine to perform operations implementing any one of example methods 1 to 9.

What is claimed is:

1. A method comprising:
performing a first set of autoscaling actions using a first autoscaler in a network-based data system, the performing the first set of autoscaling actions including:
receiving, by the first autoscaler, a dataset of workload information related to a plurality of computing resources arranged in one or more clusters in the network-based data system; and
generating a first autoscaling action for at least one cluster of the one or more clusters based on the dataset of workload information, the first autoscaling action being one type of a plurality of autoscaling actions types capable of being performed by the first autoscaler; and
performing a second set of autoscaling actions using a second autoscaler in the network-based data system, the performing the second set of autoscaling actions including:
receiving, by the second autoscaler, a subset of the dataset of workload information; and
generating a second autoscaling action for at least one cluster of the one or more clusters based on the subset of the dataset of workload information.

2. The method of claim 1, the second autoscaler being limited to performing a single type of autoscaling action.

3. The method of claim 2, wherein the single type of autoscaling action is scaling out to add one or more computing resources.

4. The method of claim 1, wherein the first autoscaler receives the dataset of workload information by reading the dataset from a metadata database in the network-based data system.

5. The method of claim 4, wherein the second autoscaler receives the subset of the dataset of workload information by reading the subset from an in-memory location provided in a telemetry service.

6. The method of claim 5, wherein the plurality of computing resources transmits the subset of the dataset of workload information to the telemetry service using remote procedure calls.

7. The method of claim 1, further comprising:
detecting a conflict between the first autoscaling action and the second autoscaling action;
cancelling the first autoscaling action and the second autoscaling action based on the conflict; and
generating a third autoscaling action by the second autoscaler in a subsequent iteration of performing the second set of autoscaling actions.

8. A machine-storage medium embodying instructions that, when executed by a machine, cause the machine to perform operations comprising:
performing a first set of autoscaling actions using a first autoscaler in a network-based data system, the performing the first set of autoscaling actions including:
receiving, by the first autoscaler, a dataset of workload information related to a plurality of computing resources arranged in one or more clusters in the network-based data system; and
generating a first autoscaling action for at least one cluster of the one or more clusters based on the dataset of workload information, the first autoscaling action being one type of a plurality of autoscaling actions types capable of being performed by the first autoscaler; and
performing a second set of autoscaling actions using a second autoscaler in the network-based data system, the performing the second set of autoscaling actions including:
receiving, by the second autoscaler, a subset of the dataset of workload information; and
generating a second autoscaling action for at least one cluster of the one or more clusters based on the subset of the dataset of workload information.

9. The machine-storage medium of claim 8, the second autoscaler being limited to performing a single type of autoscaling action.

10. The machine-storage medium of claim 9, wherein the single type of autoscaling action is scaling out to add one or more computing resources.

11. The machine-storage medium of claim 8, wherein the first autoscaler receives the dataset of workload information by reading the dataset from a metadata database in the network-based data system.

12. The machine-storage medium of claim 11, wherein the second autoscaler receives the subset of the dataset of workload information by reading the subset from an in-memory location provided in a telemetry service.

13. The machine-storage medium of claim 12, wherein the plurality of computing resources transmits the subset of the dataset of workload information to the telemetry service using remote procedure calls.

14. The machine-storage medium of claim 8, further comprising:
detecting a conflict between the first autoscaling action and the second autoscaling action;
cancelling the first autoscaling action and the second autoscaling action based on the conflict; and
generating a third autoscaling action by the second autoscaler in a subsequent iteration of performing the second set of autoscaling actions.

15. A system comprising:
at least one hardware processor; and
at least one memory storing instructions that, when executed by the at least one hardware processor, cause the at least one hardware processor to perform operations comprising:
performing a first set of autoscaling actions using a first autoscaler in a network-based data system, the performing the first set of autoscaling actions including:
receiving, by the first autoscaler, a dataset of workload information related to a plurality of computing resources arranged in one or more clusters in the network-based data system; and
generating a first autoscaling action for at least one cluster of the one or more clusters based on the dataset of workload information, the first autoscaling action being one type of a plurality of autoscaling actions types capable of being performed by the first autoscaler; and
performing a second set of autoscaling actions using a second autoscaler in the network-based data system, the performing the second set of autoscaling actions including:
receiving, by the second autoscaler, a subset of the dataset of workload information; and
generating a second autoscaling action for at least one cluster of the one or more clusters based on the subset of the dataset of workload information.

16. The system of claim 15, the second autoscaler being limited to performing a single type of autoscaling action.

17. The system of claim 16, wherein the single type of autoscaling action is scaling out to add one or more computing resources.

18. The system of claim 15, wherein the first autoscaler receives the dataset of workload information by reading the dataset from a metadata database in the network-based data system.

19. The system of claim 18, wherein the second autoscaler receives the subset of the dataset of workload information by reading the subset from an in-memory location provided in a telemetry service.

20. The system of claim 19, wherein the plurality of computing resources transmits the subset of the dataset of workload information to the telemetry service using remote procedure calls.

21. The system of claim 15, the operations further comprising:
detecting a conflict between the first autoscaling action and the second autoscaling action;
cancelling the first autoscaling action and the second autoscaling action based on the conflict; and
generating a third autoscaling action by the second autoscaler in a subsequent iteration of performing the second set of autoscaling actions.
